(19) United States
(12) Patent Application Publication
(10) Pub. No.: US 2017/0046786 A1
(43) Pub. Date: Feb. 16, 2017

(54) INSURANCE-APPRAISAL PHOTOGRAPHY CARD SYSTEM AND METHOD

(71) Applicant: Fliptakes L. L. C., Mankato, MN (US)

(72) Inventor: David M. Johnston, Mankato, MN (US)

(21) Appl. No.: 15/236,841

(22) Filed: Aug. 15, 2016

Related U.S. Application Data
(60) Provisional application No. 62/205,446, filed on Aug. 14, 2015.

(51) Int. Cl. G06Q 40/08; G06T 7/60; G06K 9/62; H04N 7/18; G06T 7/00

(52) U.S. Cl. CPC G06Q 40/08; H04N 7/18; G06T 7/004; G06T 7/0004; G06K 9/6267; G06T 7/60; G06T 2207/30108

(57) ABSTRACT

An apparatus and method for quickly and permanently annotating photographs used to arrive at documenting levels of damage that may have been sustained by insured items, such as cars, houses, boats, and the like. A photograph-annotation device that includes a first plurality of cards including a first card and a second card, wherein each one of the first plurality of cards has a different geometry relative to others of the first plurality of cards, wherein each one of the first plurality of cards includes one or more information labels; and an attachment mechanism configured to hold the first plurality of cards together such that the first plurality of cards is in a stack having a top card, and such that each one of the first plurality of cards can be rotated around a common axis relative to others of the first plurality of cards in the stack.

### CROSS-REFERENCE TO RELATED APPLICATIONS

This application claims priority benefit, under 35 U.S.C. §119(e), of U.S. Provisional Patent Application 62/205,446 filed Aug. 14, 2015 by David M. Johnston, titled “INSURANCE-APPRAISAL PHOTOGRAPHY CARD SYSTEM AND METHOD,” which is incorporated herein by reference in its entirety.

### FIELD OF THE INVENTION

The present invention relates to devices and methods that document appraisals for insurance-claim settlements, and in particular to systems and methods for quickly, automatically, and permanently annotating photographs used to document levels of damage that may have been sustained by insured items, such as cars, houses, boats, and the like.

### BACKGROUND OF THE INVENTION

Persons appraising damage for insurance claims need photographs of the property to document the asserted damage. The photographs need to be annotated as to what object or condition is being documented in the photograph. This annotation is typically done at a computer workstation at a location distant from the scene and at time much later than the time that the image was acquired, and takes up an inconvenient amount of the appraiser's day, especially when a large number of photographs are being annotated. Also, it can be difficult for the appraiser to remember where on the damaged property is the image from (for example, is the image of the front or back roof, which direction was the camera pointing, and the like). The metadata stored in each image file can provide a limited amount of information (such as GPS coordinates that can identify the location of the property and perhaps even elevation, and other metadata that is automatically recorded by the camera itself without human intervention or input and can include timestamps, camera and lens information, and the like). Many cameras have the capability of “burning” a timestamp in the viewable image, so that when the image is printed or shown on a computer screen, the time is readily apparent. Much more metadata (i.e., data describing the data in the image) can and often is embedded in the image file of each digital photograph. Computer programs, such as exiftool.exe, are available on the internet (such as available as of Aug. 10, 2016 at www.sno.phy.queensu.ca/˜phil/exiftool/) and these can extract such metadata from the image files and store the extracted metadata in a text file associated with the image, and a human must still match a particular text file with its associated image file. However, even with such a software tool there is information that varies from image to image and that is specific and useful to the insurance industry that cannot be easily embedded by the camera into each image file, and there is a lot of work for the appraiser to use such a software tool to extract the metadata and associate each respective set of metadata with each photograph in the appraiser's report.

U.S. Pat. No. 3,528,731 to Joseph W. Bird (hereinafter, “Bird”) titled “MOVIE TITLER, CLAP-BOARD STYLE” issued Sep. 15, 1970, and is incorporated herein by reference in its entirety. Bird describes a movie titler of the type having two hinged parts that can be clapped together to indicate the beginning of a scene. The hinge between the parts is constructed as two parallel spaced flanges between which the parts are mounted to provide good action by providing a pivot point for the clapper portion spaced away from the fixed portion. Clap-board apparatus such as this is held by a person at a location within the view of the camera at the start of a movie capture both to identify the movie clip and to provide a cross reference between the images being obtained and the sound being recorded. Such apparatus is not particularly useful of annotating different information on each image when taking a series of appraisal images.

Mugshot boards with removable and replaceable lettering are also known for annotating mugshot images of suspected criminals, but it is time consuming to replace such lettering and use of such boards when taking appraisal images on rooftops is totally inappropriate.

U.S. Pat. No. 6,947,578 to Seung Yop Lee (hereinafter, “Lee”) titled “INTEGRATED IDENTIFICATION DATA CAPTURE SYSTEM” issued Sep. 20, 2005, and is incorporated herein by reference in its entirety. Lee describes a system for capturing identification data pertaining to a subject is provided. The system generally comprises a main support assembly spaced a predetermined distance from the subject; a plurality of image capture devices displaceably supported by the main support assembly; at least one auxiliary data capture device; and, a programmably configured workstation operably coupled to each of the devices for automatically controlling those devices responsive to user actuation thereof. Image capture devices operate to concurrently generate a plurality of graphic representations of the subject. They are adjustably disposed for respectively rendering the graphic representations from preselected view orientations. At least one auxiliary data capture device is operable to capture a predetermined biometric parameter pertaining to the subject.

U.S. Pat. No. 7,248,285 to Bradford H. Needham (hereinafter, “Needham”) titled “METHOD AND APPARATUS FOR AUTOMATIC PHOTOGRAPH ANNOTATION” issued Jul. 24, 2007, and is incorporated herein by reference in its entirety. Needham describes a system, apparatus and method for automatically annotating digital images. An electronic capture device captures a digital representation of a scene. An information tag device is utilized to store identification data for identifying the scene. A tag-reader receives the identification data from the information tag device. A database stores information for the information tag device. A communication device communicates with the database. When identification data is transmitted to the database, information for an annotation provider is transmitted from the database to the communication device. A program executed by the communication device controls communication of the identification data with the database.

U.S. Pat. No. 8,830,523 to Diane M. Miller (hereinafter, “Miller”) titled “ARTICLE IMAGE ANNOTATION SYSTEM” issued Sep. 9, 2014, and is incorporated herein by reference in its entirety. Miller describes an article image annotation system including an imager and a transparent sheet discrete from the imager having a first face adapted to engage an imageable surface of an article and a second face adapted to receive annotations and adapted for engagement with the imager to allow imaging of the imageable surface of the article in association with the annotation through the transparent sheet, thereby producing an annotated article image.

U.S. Patent Application Publication 2005/0160641 to Hilda Camacho et al. (hereinafter, “Camacho et al.”) titled “COLOR SAMPLE FAN DECK WITH PEEL OFF FEATURE” published Jul. 28, 2005, and is incorporated herein by reference in its entirety. Camacho et al. describe a sample display primarily intended to display colors and textures. The sample display includes multiple cards removably affixed to sheets. Colors and textures are displayed on swatches affixed to the cards. Individual cards can readily be removed from the sheets. The sheets can be bound together such as in a typical fan display.

U.S. Pat. No. 6,474,693 to Jude Gregory Nitsche (hereinafter, “Nitsche”) titled “POSTER-STYLE NOVELTY ITEM” issued Nov. 5, 2016, and is incorporated herein by reference in its entirety. Nitsche describes a novelty item in which pages can be rotated about a fastener to form an integrated image on one side of the pages while forming independent pages of text and/or graphics on the other side. Such an item can be used as a combination comic book and poster. By including at least one die-cut hole, the combination comic book and poster can be hung on the wall using the nail or hook.

U.S. Pat. No. 6,665,965 to Mario A. Turchi et al. (hereinafter, “Turchi et al.”) titled “ERGONOMIC COLOR SAMPLE FAN DECK” issued Nov. 5, 2016, and is incorporated herein by reference in its entirety. Turchi et al. describe a fan deck display having a case including a center wall joined between a pair of side walls. Each of the side walls has a longitudinal free edge with a plurality of undulations formed therein. A plurality of color strips are movably connected to the case. Each of the color strips has a plurality of color swatches and a free edge with a plurality of undulations formed therein. When the color strips are in a retracted position inside the case, the undulations in the color strips are aligned with the undulations in the free edges.

U.S. Reissued Pat. No. RE44,113 E to Steven B. Winter et al. (hereinafter, “Winter et al.”) titled “METHOD OF MAKING COLOR FAN DECK” was reissued Apr. 2, 2013, and is incorporated herein by reference in its entirety. Winter et al. describe a paint color sample display device for the illustration of paint colors and a method for making such a color display device. The color display device may be a color fan deck which displays color on each side of the blades of the fan deck. The fan blades include a painted polymeric film laminated to both sides of a base paper to form a painted film/base paper/painted film laminate for the fan blades.

Accordingly, there is a need in the art for an improved photograph annotation apparatus and method.

### SUMMARY OF THE INVENTION

In some embodiments, the present invention provides an improved photograph annotation apparatus and method. The apparatus and method includes label sticks and the method of taking photographs (digital images) while holding the label sticks in the field of view of the camera obtaining the images. In some embodiments, the label sticks are referred to as Fliptakes™ label sticks.

In some embodiments, the present invention provides a method of annotating a photograph that includes providing a first plurality of cards, wherein each one of the first plurality of cards has a different geometry relative to others of the first plurality of cards, wherein each one of the first plurality of cards includes one or more information labels; connecting the first plurality of cards together such that the first plurality of cards is in a stack having a top card, and such that each one of the first plurality of cards can be rotated around a common axis relative to others of the first plurality of cards in the stack; selecting at least a first card of the first plurality of cards; positioning the selected first card such that the one or more information labels of the selected first card is visible in a scene; and capturing a digital image of the scene including an image of the selected first card.

In some embodiments, the present invention provides a photograph-annotation device that includes a first plurality of cards including a first card and a second card, wherein each one of the first plurality of cards has a different geometry relative to others of the first plurality of cards, wherein each one of the first plurality of cards includes one or more information labels; and an attachment mechanism configured to hold the first plurality of cards together such that the first plurality of cards is in a stack having a top card, and such that each one of the first plurality of cards can be rotated around a common axis relative to others of the first plurality of cards in the stack.

### BRIEF DESCRIPTION OF THE FIGURES

FIG. 1A is a front-view diagram of a fanned-out photograph-annotation system 101, according to some embodiments of the present invention.

FIG. 1B is a front-view diagram of photograph-annotation system 101 in an unassembled configuration, according to some embodiments of the present invention.

FIG. 1C is a diagram of photograph-annotation system 101 being used to annotate a photograph of a gutter system on a building roof.

FIG. 2A is a front-view diagram of an unassembled photograph-annotation system 201, according to some embodiments of the present invention.

FIG. 2B-1 is a front-view diagram of photograph-annotation system 201 in an assembled and collapsed configuration, according to some embodiments of the present invention.

FIG. 2B-2 is a front-view diagram of photograph-annotation system 202 in an assembled and collapsed configuration, according to some embodiments of the present invention.

FIG. 2C-1 is a back-view diagram of photograph-annotation system 201 in an assembled and collapsed configuration, according to some embodiments of the present invention.

FIG. 2C-2 is a back-view diagram of photograph-annotation system 202 in an assembled and collapsed configuration, according to some embodiments of the present invention.

FIG. 3A is a front-view diagram of an unassembled photograph-annotation system 301, according to some embodiments of the present invention.

FIG. 3B is a back-view diagram of photograph-annotation system 301 in an assembled and collapsed configuration, according to some embodiments of the present invention.

FIG. 3C is a back-view diagram of photograph-annotation system 301 in an assembled configuration during selection of a desired label stick, according to some embodiments of the present invention.

FIG. 3D is a diagram of photograph-annotation system 301 in an assembled and collapsed configuration with the selected label stick appearing in the front, according to some embodiments of the present invention.

FIG. 4A is an image of a portion of an unassembled photograph-annotation system 401, according to some embodiments of the present invention.

FIG. 4B is an image of another portion of the unassembled photograph-annotation system 401, according to some embodiments of the present invention.

FIG. 5A is a diagram of photograph-annotation system 501 in an assembled and collapsed configuration, according to some embodiments of the present invention.

FIG. 5B is a diagram of photograph-annotation system 501 in an assembled configuration during selection of a desired label stick, according to some embodiments of the present invention.

FIG. 5C is a diagram of photograph-annotation system 501 in an assembled and collapsed configuration with the selected label stick appearing in the front, according to some embodiments of the present invention.

FIG. 5D is a diagram of a photograph-annotation system 502 in an assembled and collapsed configuration, according to some embodiments of the present invention.

FIG. 6 is a table 601 showing one embodiment of labels that are used in combination with one or more embodiments of the above-described label sticks.

FIG. 7A is a first portion 701 of a table 700 showing one embodiment of labels in an ELEVATION category that are used in combination with one or more embodiments of the above-described label sticks.

FIG. 7B is a second portion 702 of table 700.

FIG. 8A is a first portion 801 of a table 800 showing one embodiment of labels in a ROOF category that are used in combination with one or more embodiments of the above-described label sticks.

FIG. 8B is a second portion 802 of table 800.

FIG. 9 is a table 901 showing one embodiment of labels that are used in combination with one or more embodiments of the above-described label sticks.

### COPYRIGHT NOTICE/PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. Copyright © 2016, Fliptakes L.L.C., All Rights Reserved.

### DETAILED DESCRIPTION OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

It is specifically contemplated that the present invention includes embodiments having combinations and subcombinations of the various embodiments and features that are individually described herein (i.e., rather than listing every combinatorial of the elements, this specification includes descriptions of representative embodiments and contemplates embodiments that include some of the features from one embodiment combined with some of the features of another embodiment, including embodiments that include some of the features from one embodiment combined with some of the features of embodiments described in the patents and application publications incorporated by reference in the present application). Further, some embodiments include fewer than all the components described as part of any one of the embodiments described herein.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

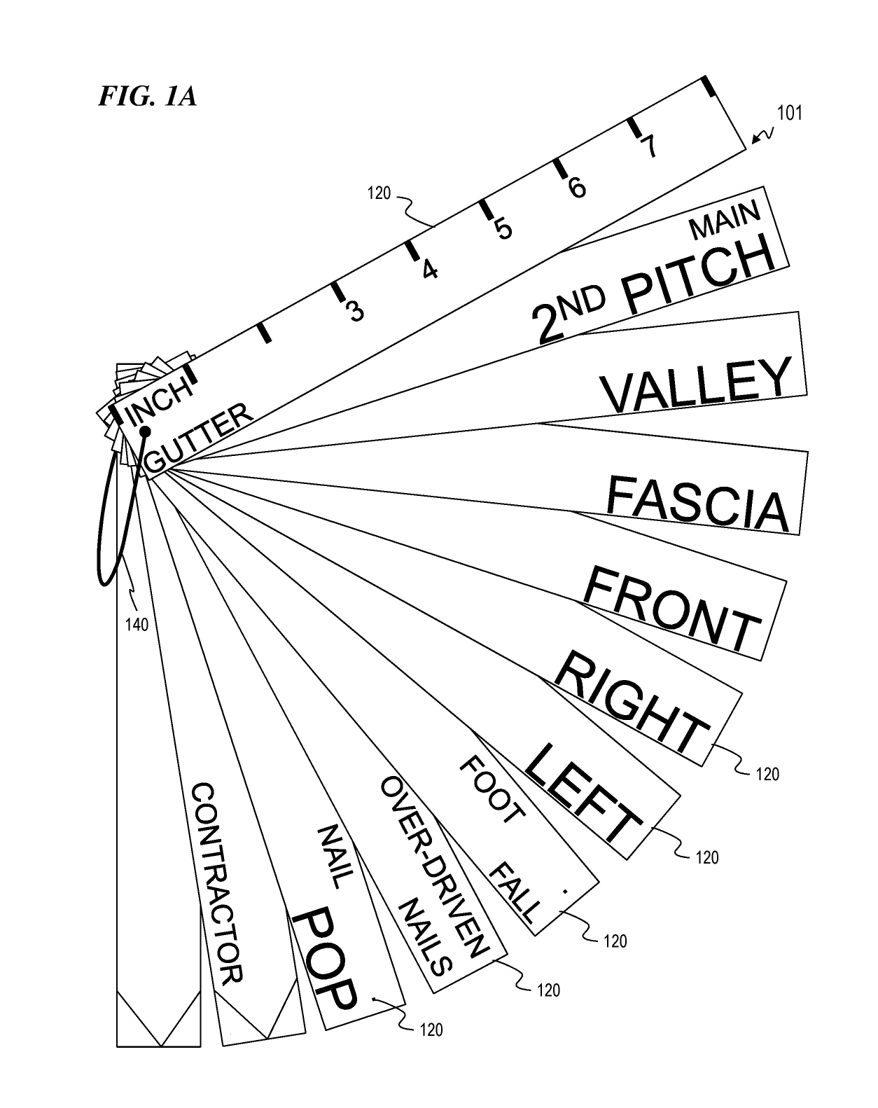

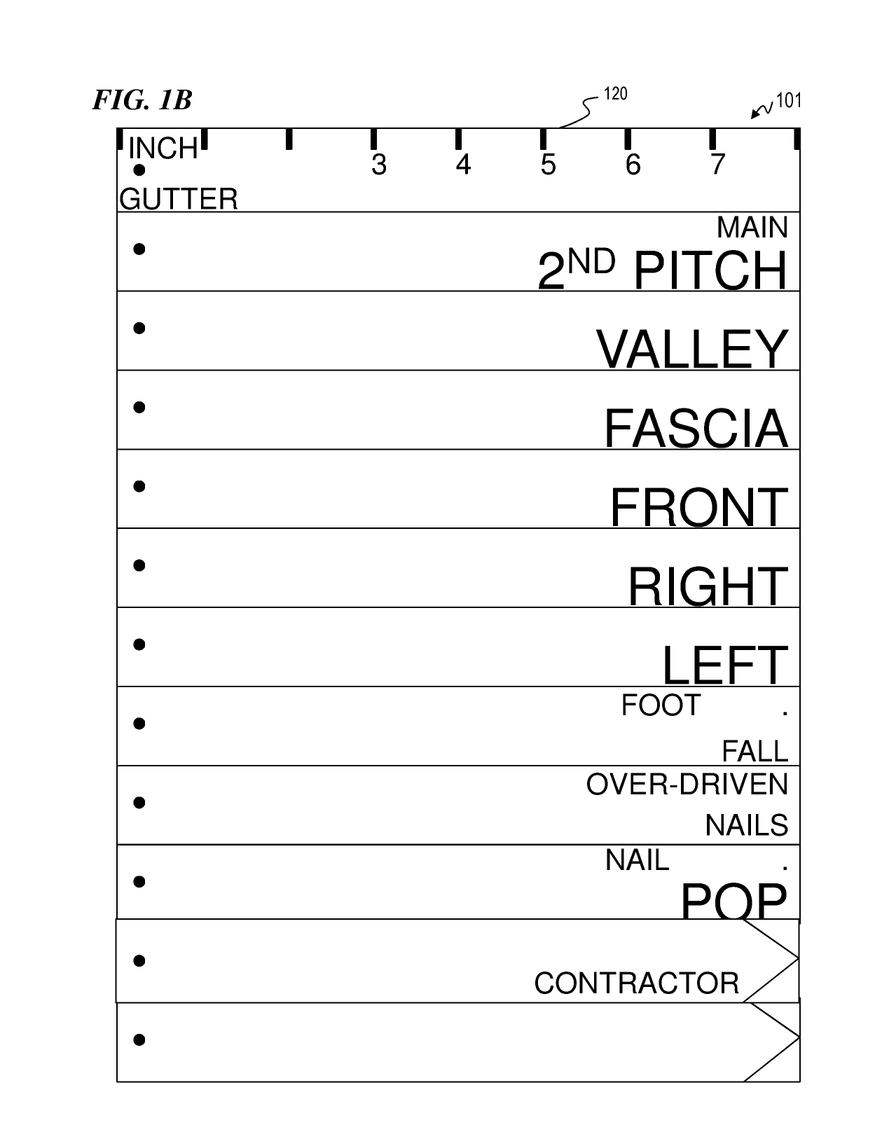

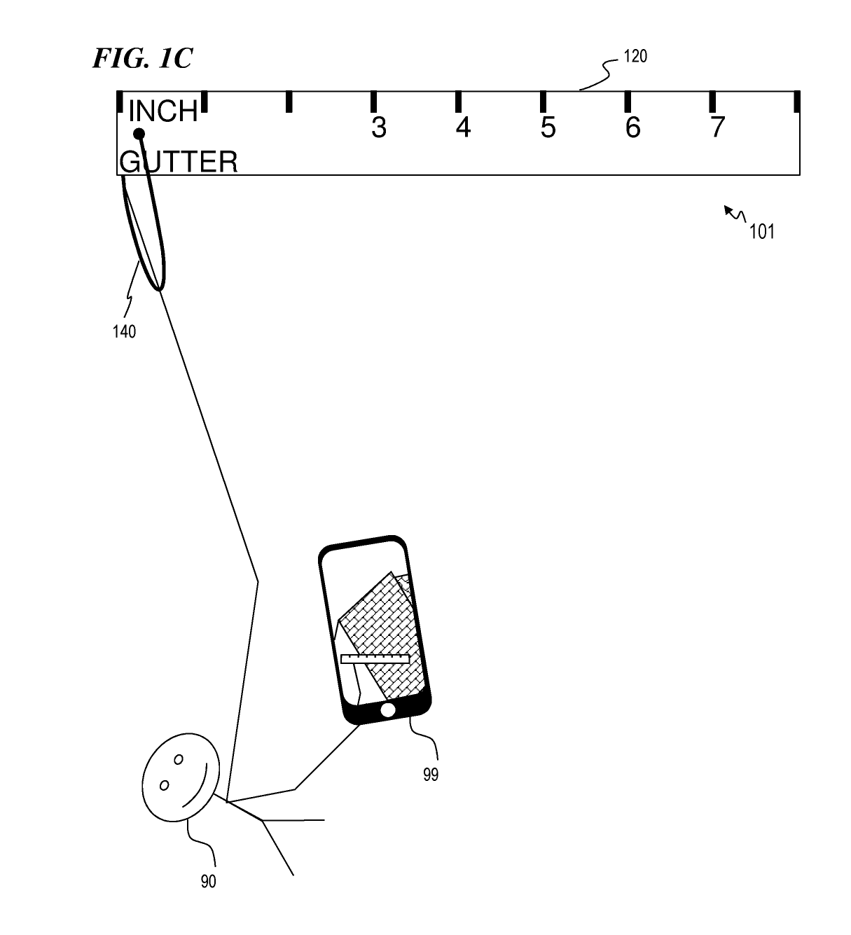

FIG. 1A is a front-view diagram of a fanned-out photograph-annotation system 101, according to some embodiments of the present invention. In some embodiments, system 101 includes a plurality of annotation label sticks 120, each label stick 120 having its own indicia (in some embodiments, each label stick's indicia are unique) that is used to annotate a photograph. For example, in some embodiments, the indicia on a label stick 120 is used to identify the object, orientation, geographic direction (e.g., north, east west, or south) or condition being documented in the photograph, and in some embodiments, ruler marks indicating a geometric scale or metric are also included on at least one of the label sticks 120. In some embodiments, as illustrated in FIG. 1A, system 101 is used to annotate photographs taken during a home or building inspection (e.g., a home inspection for an insurance claim, a pre-purchase buyer's home inspection, a construction inspection, or the like), and label sticks 120 include indicia such as “FRONT”, “VALLEY”, “NAIL POP”, “FASCIA”, and the like. In some such embodiments, the indicia used for system 101 varies depending on the geographic location of the home or building (e.g., in Florida, the indicia might include labels for tile roofing, whereas, in the Midwest, the indicia might include labels for asphalt-shingle roofing) In other embodiments, system 101 is used to annotate photographs taken during an automobile inspection (e.g., an automobile inspection for an insurance claim), and label sticks 120 include indicia such as “HOOD”, “TRUNK”, “DRIVER′S-SIDE-FRONT QUARTER PANEL”, “PASSENGER'S-SIDE-FRONT QUARTER PANEL”, and the like. In other embodiments, system 101 is used to annotate photographs of a person (e.g., photographs taken of a medical patient, photographs taken of an accident or assault victim, and the like), and label sticks 120 include indicia such as “RIGHT ANKLE”, “LEFT ANKLE”, “RIGHT FOREARM”, “LEFT FOREARM”, and the like.

In some embodiments, the plurality of label sticks 120 is held together on a ring 140 having a sufficiently large diameter to permit easy rotation of any given one of the. In some such embodiments, ring 140 allows label sticks 120 to be fanned out (e.g., as shown in FIG. 1A) so that a desired label stick 120 can be selected, and then the non-selected label sticks of the plurality of label sticks 120 can be rotated around the ring such that the selected label stick 120 is placed in the front of the plurality of label sticks 120. In other embodiments, the plurality of label sticks 120 are held together with an attachment mechanism (not shown) such as a grommet and a rivet (in some such embodiments, a snap grommet or a screw grommet), a screw, a nut and bolt, or the like.

FIG. 1B is a front-view diagram of photograph-annotation system 101 in an unassembled configuration, according to some embodiments of the present invention.

FIG. 1C is a diagram of photograph-annotation system 101 being used to annotate a photograph of a gutter system on a building roof. In some embodiments, user 90 takes a photograph of the gutter system with the digital camera in their smartphone or other personal electronic device 99. In some such embodiments, user 90 annotates the photograph of the gutter system by holding system 101 (with the desired label stick 120 placed in the front of system 101) in front of the gutter system while taking the photograph.

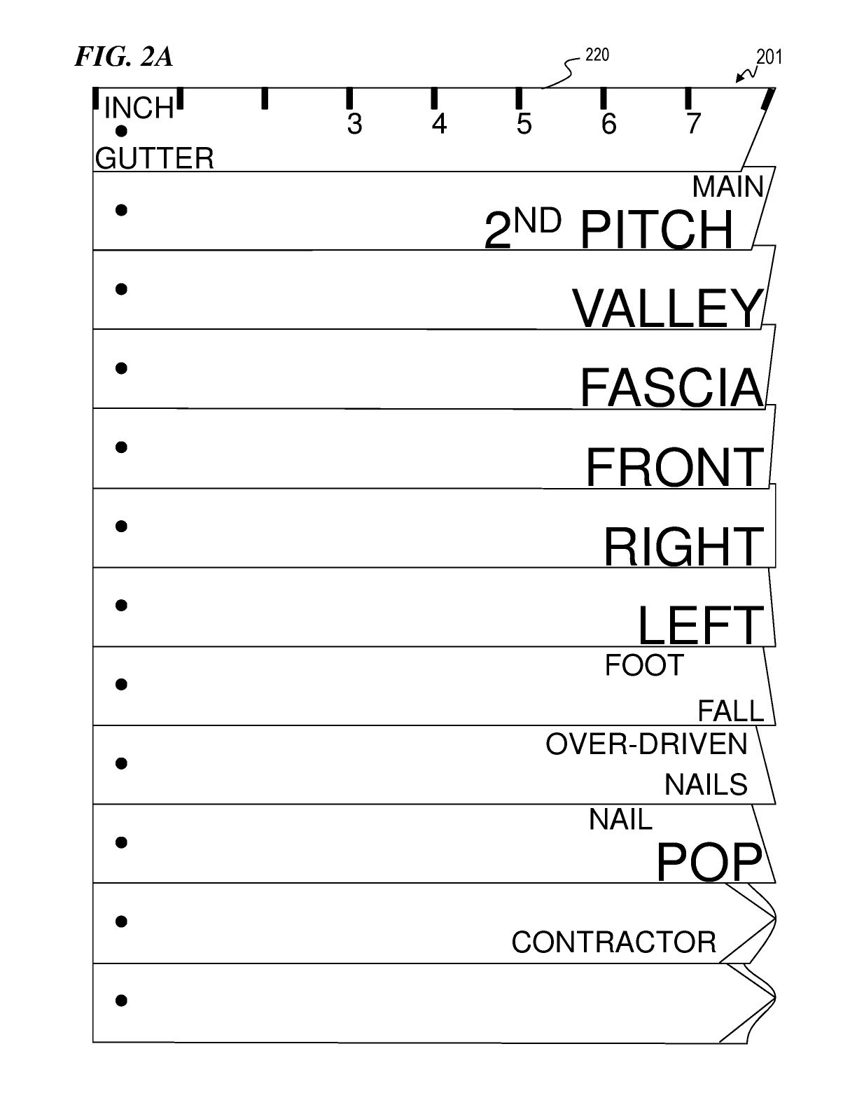

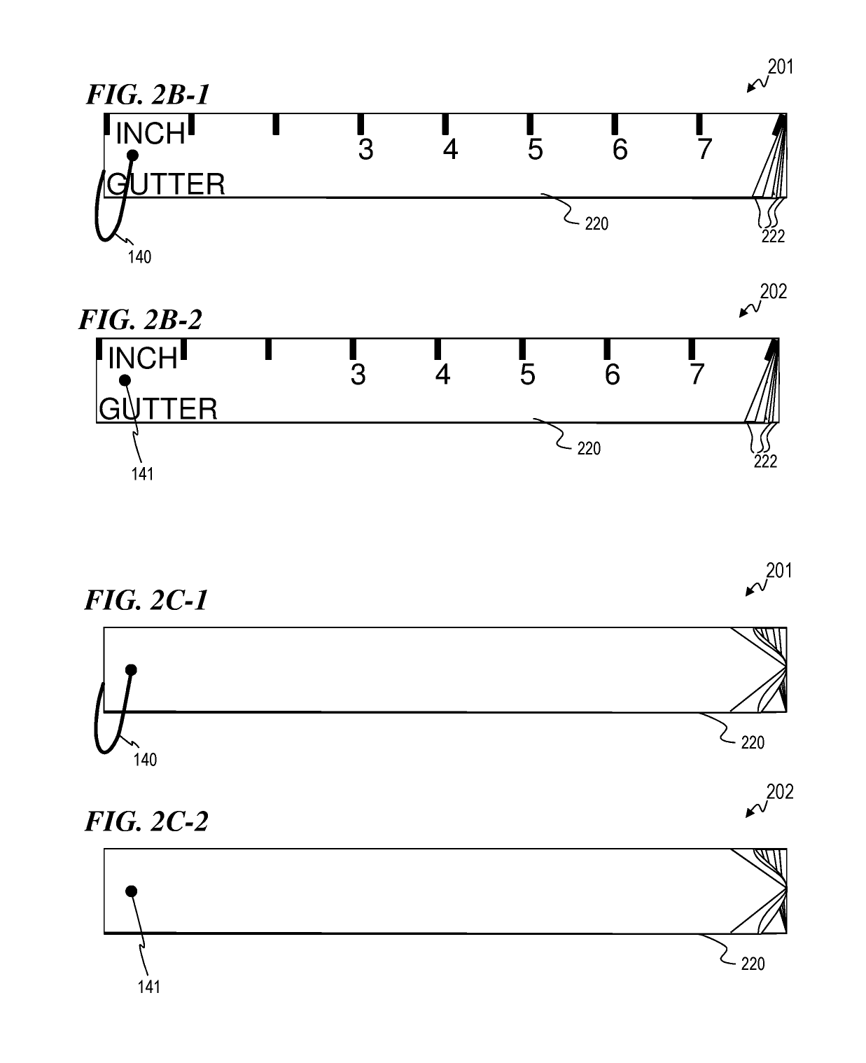

FIG. 2A is a front-view diagram of an unassembled photograph-annotation system 201, according to some embodiments of the present invention. In some embodiments, system 201 includes a plurality of annotation label sticks 220, each label stick 220 having its own indicia (in some embodiments, each label stick's indicia are unique) that is used to annotate a photograph (e.g., in some embodiments, the indicia on a label stick 220 is used to identify the object or condition being documented in the photograph). In some embodiments, label sticks 220 are substantially similar to label sticks 120 of FIG. 1B except that the end of each label stick 220 opposite the ring hole has a unique shape such that a desired label stick 220 can be selected from among the plurality of label sticks 220 more efficiently (e.g., in some embodiments, the uniquely-shaped ends of label sticks 220 allow a desired label stick 220 to be selected without having to place system 201 in a fanned-out configuration).

FIG. 2B-1 is a front-view diagram of photograph-annotation system 201 in an assembled and collapsed configuration, according to some embodiments of the present invention.

FIG. 2B-2 is a front-view diagram of a photograph-annotation system 202 in an assembled and collapsed configuration, according to some embodiments of the present invention. In some embodiments, system 202 is identical to system 201 except that instead of ring 140, the plurality of annotation label sticks 220 are held together with an attachment mechanism 141 such as a grommet and a rivet (in some such embodiments, a snap grommet or a screw grommet), a screw, a nut and bolt, or the like.

FIG. 2C-1 is a back-view diagram of photograph-annotation system 201 in an assembled and collapsed configuration, according to some embodiments of the present invention.

FIG. 2C-2 is a back-view diagram of photograph-annotation system 202 in an assembled and collapsed configuration, according to some embodiments of the present invention.

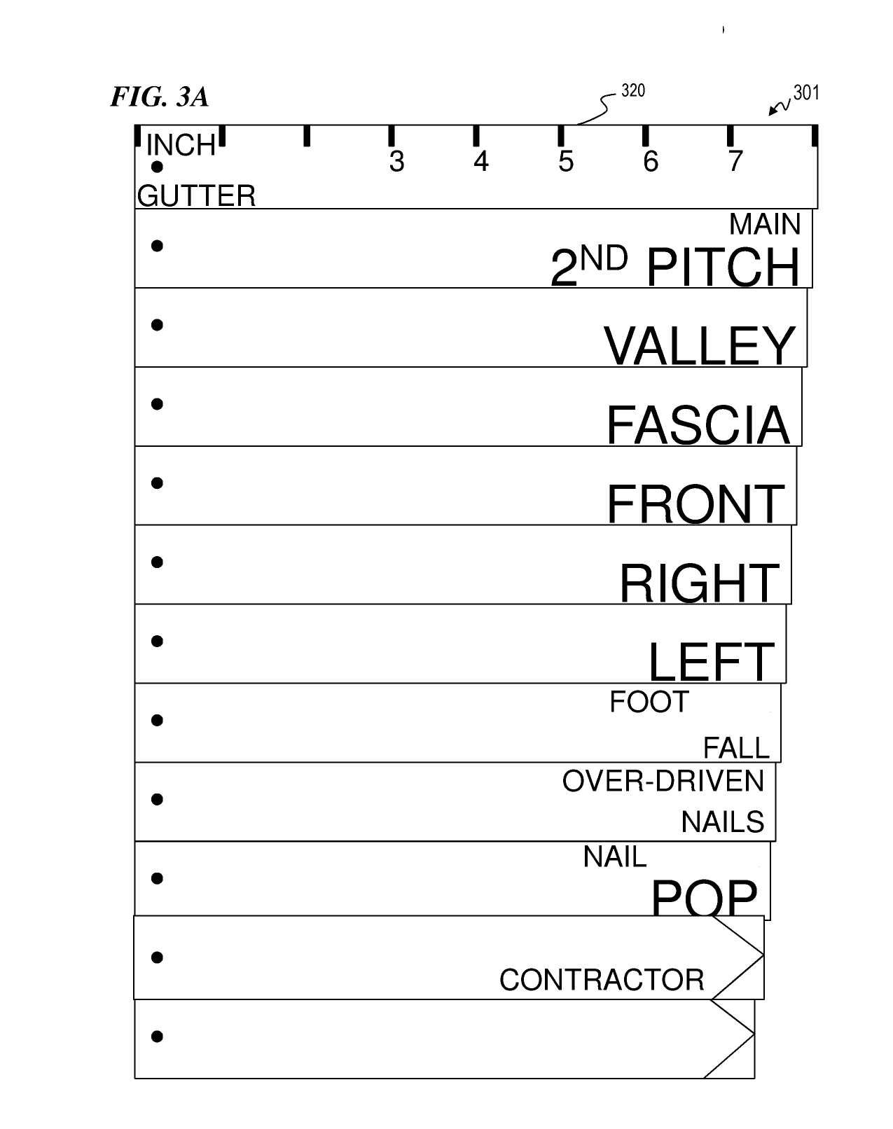

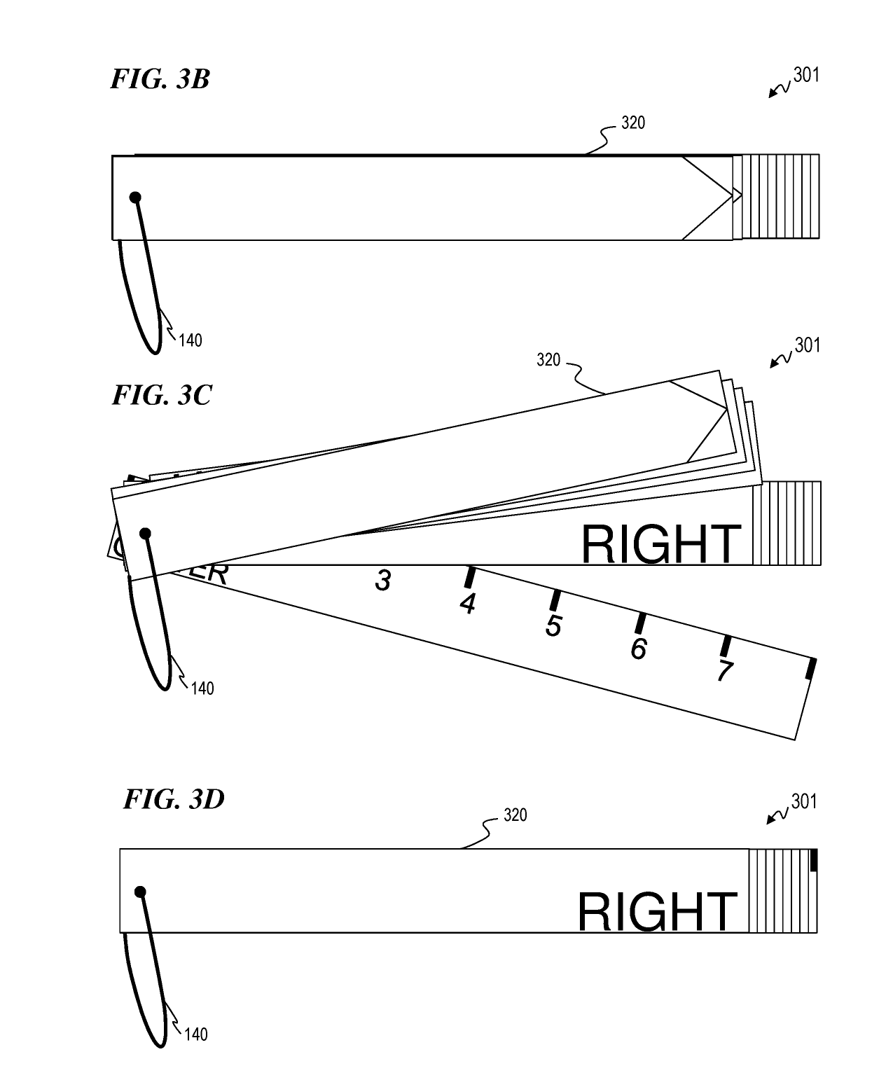

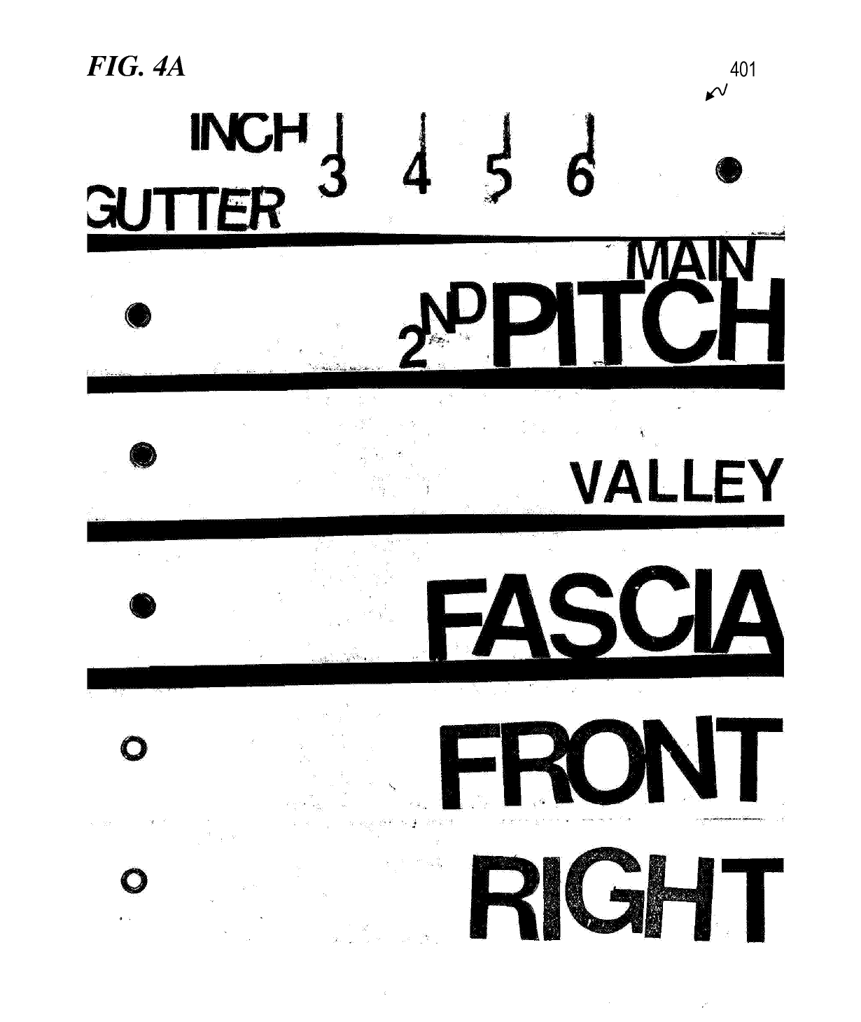

FIG. 3A is a front-view diagram of an unassembled photograph-annotation system 301, according to some embodiments of the present invention. In some embodiments, system 301 includes a plurality of annotation label sticks 320, each label stick 320 having its own indicia (in some embodiments, each label stick's indicia are unique) that is used to annotate a photograph (e.g., in some embodiments, the indicia on a label stick 320 is used to identify the object or condition being documented in the photograph). In some embodiments, label sticks 320 are substantially similar to label sticks 120 of FIG. 1B except that each label stick 330 has a unique overall length such that a desired label stick 320 can be selected from among the plurality of label sticks 320 more efficiently (e.g., in some embodiments, the varied-length label sticks 320 allow a desired label stick 320 to be selected without having to place system 301 in a fanned-out configuration).

FIG. 3B is a back-view diagram of photograph-annotation system 301 in an assembled and collapsed configuration, according to some embodiments of the present invention.

FIG. 3C is a back-view diagram of photograph-annotation system 301 in an assembled configuration during selection of a desired label stick, according to some embodiments of the present invention. In some embodiments, the desired label stick 320 has been selected (e.g., in some embodiments, the selected label stick 320 is the label stick 320 with the indicia “RIGHT” as shown in FIG. 3C), and FIG. 3C represents the rotating of the other label sticks 320 in system 310 around ring 140 such that the selected label stick 320 is placed in front of the others of the plurality of label sticks 320.

FIG. 3D is a diagram of photograph-annotation system 301 in an assembled and collapsed configuration with the selected label stick appearing in the front, according to some embodiments of the present invention.

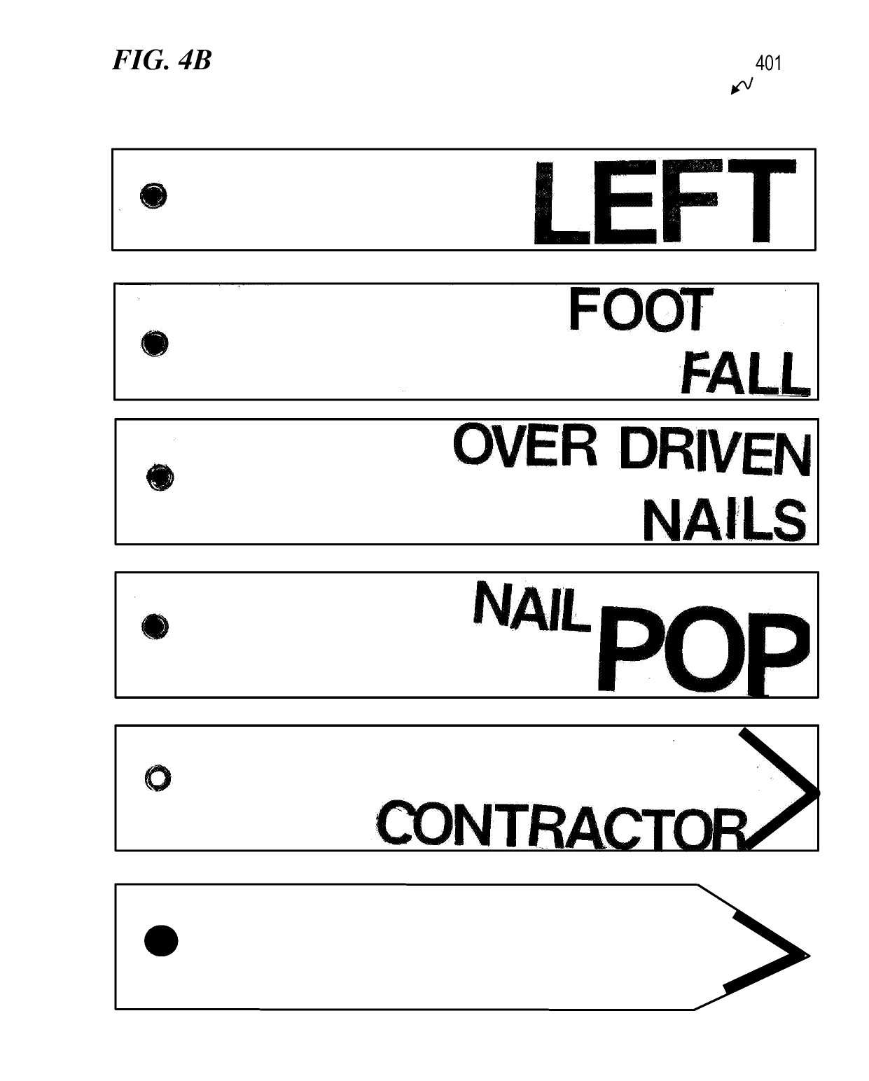

FIG. 4A is a photograph of a portion of an unassembled photograph-annotation system 401, according to some embodiments of the present invention.

FIG. 4B is a photograph of another portion of the unassembled photograph-annotation system 401, according to some embodiments of the present invention.

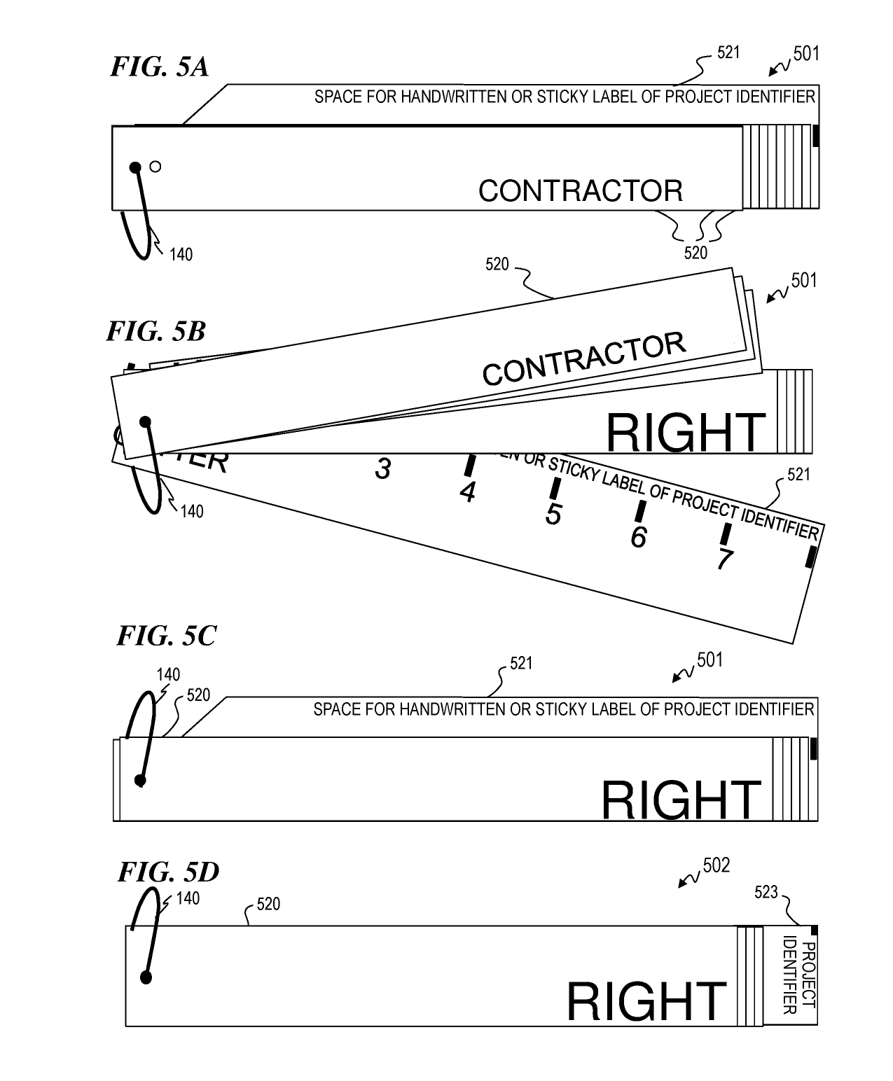

FIG. 5A is a diagram of photograph-annotation system 501 in an assembled and collapsed configuration, according to some embodiments of the present invention. In some embodiments, system 501 includes a plurality of annotation label sticks 520, each label stick 520 having its own indicia (in some embodiments, each label stick's indicia are unique) that is used to annotate a photograph (e.g., in some embodiments, the indicia on a label stick 520 is used to identify the object or condition being documented in the photograph). In some embodiments, system 501 is substantially similar to system 101 except that, in addition to label sticks 520, system 501 also includes a project-identifier stick 521. In some embodiments, stick 521 includes its own indicia used to annotate a photograph, and stick 521 is also wider than sticks 520 such that stick 521 has an extra space for identifying the project associated with the photographs being annotated. In some such embodiments, the project identification is handwritten directly on the extra space of stick 521. In other such embodiments, the project identification is written or printed on a sticky label that is then placed on the extra space of stick 521. In some embodiments, the extra width of stick 521 allows the project identification placed in the extra space of stick 521 to be visible regardless of where stick 521 is located within system 501.

FIG. 5B is a diagram of photograph-annotation system 501 in an assembled configuration during selection of a desired label stick, according to some embodiments of the present invention.

FIG. 5C is a diagram of photograph-annotation system 501 in an assembled and collapsed configuration with the selected label stick 520 appearing in the front, according to some embodiments of the present invention. In some embodiments, as illustrated by FIG. 5C, the extra space of project-identifier stick 521 is visible even though stick 521 is not the label stick located at the front of system 501.

FIG. 5D is a diagram of a photograph-annotation system 502 in an assembled and collapsed configuration, according to some embodiments of the present invention. In some embodiments, system 502 is substantially similar to system 501 except that system 502 includes a project-identifier stick 523 that is longer than label sticks 520 (as opposed to the project-identifier stick 521 of FIG. 5C that has a greater width than label sticks 520). In some such embodiments, the extra length of stick 523 allows the project identification placed in the extra space of stick 523 to be visible regardless of where stick 523 is located within system 502.

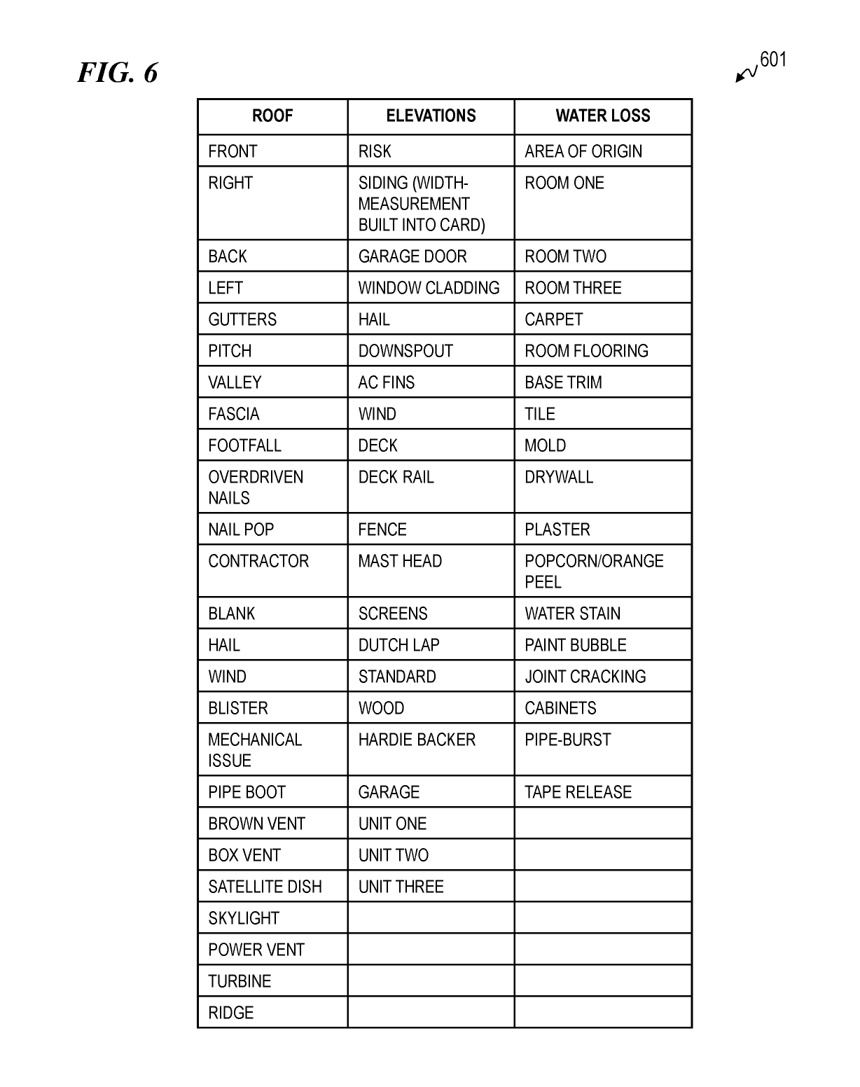

FIG. 6 is a table 601 showing one embodiment of labels that are used in combination with one or more embodiments of the above-described label sticks. In some embodiments, each column represents a category of labels (e.g., Roof, Elevations, Water Loss, and the like) used on a respective plurality of label sticks. In some embodiments, the label sticks for all of the labels in table 601 are held together in a single collection of label sticks (in some such embodiments, each category is distinguished within the single collection using a color-coded bar at the end of each respective label stick; in other such embodiments, each category is distinguished within the single collection using any other suitable approach such as the embodiments described in FIGS. 2A-2C, FIGS. 3A-3D, and the like). In other embodiments, the label sticks for each category of labels are held together as separate, category-based collections of label sticks (e.g., a first collection of held-together label sticks for Roof labels, a second collection of held-together label sticks for Elevations labels, and a third collection of held-together label sticks for Water Loss labels).

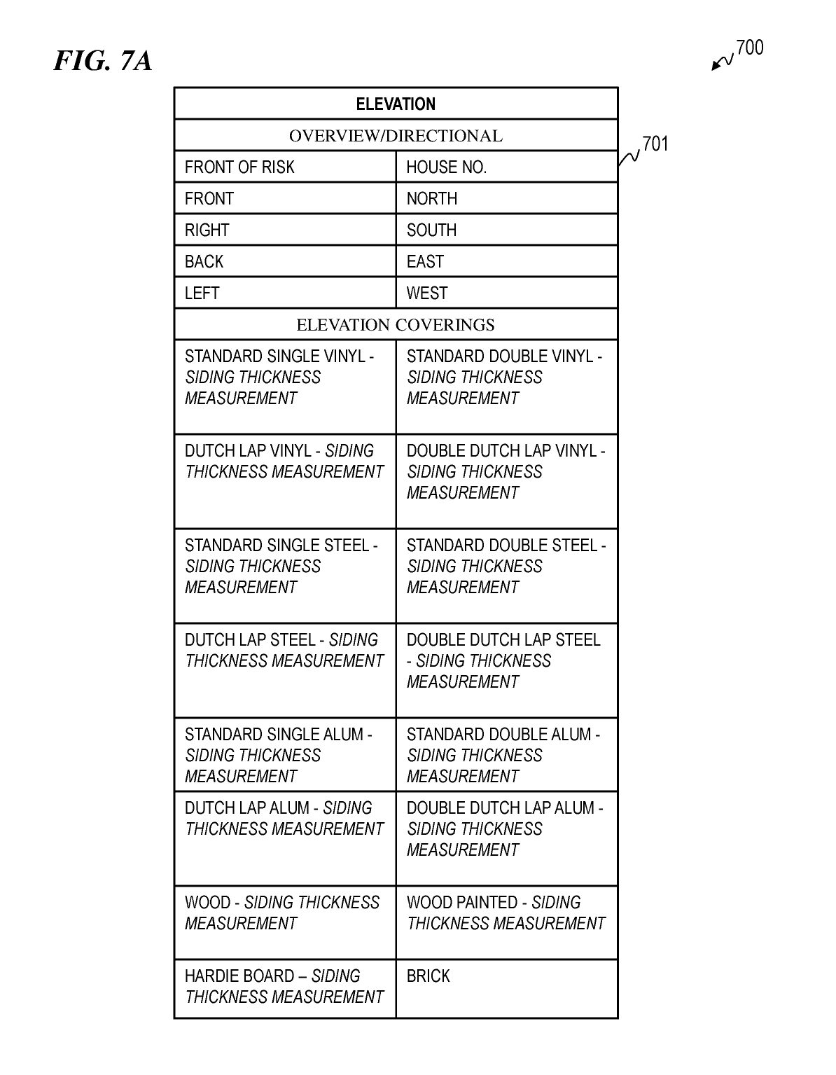

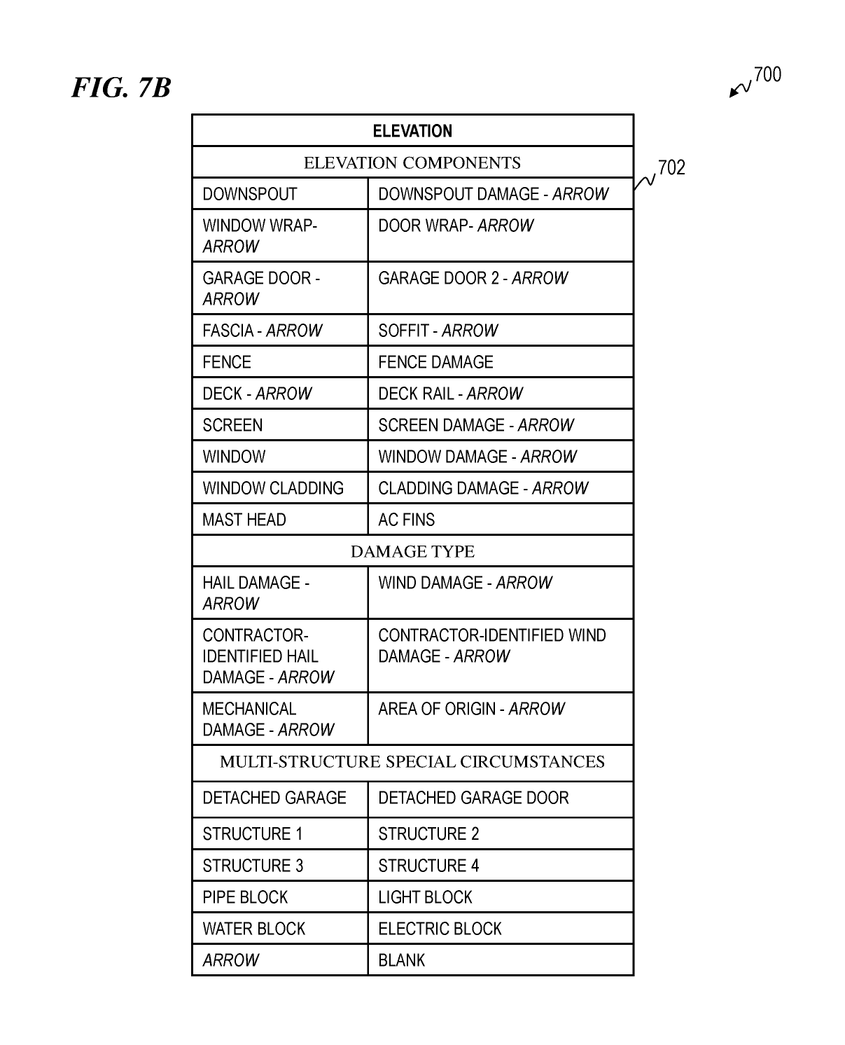

FIG. 7A is a first portion 701 of a table 700 showing one embodiment of labels in an ELEVATION category that are used in combination with one or more embodiments of the above-described label sticks. In some embodiments, each non-bolded, all-caps descriptor (e.g., “ELEVATION COVERINGS”) represents a subcategory of labels. In some embodiments, the label sticks for all of the labels in table 700 (both FIG. 7A and FIG. 7B) are held together in a single collection of label sticks (in some such embodiments, each subcategory is distinguished within the single collection using a color-coded bar at the end of each respective label stick; in other such embodiments, each subcategory is distinguished in some other suitable manner such as the embodiments described in FIGS. 2A-2C, FIGS. 3A-3D, and the like). In some embodiments, the two columns of labels in table 700 represent labels used on the front and back sides of the label sticks (e.g., in some embodiments, each respective row of labels represents the front-side label (left-hand column) and back-side label (right-hand column) used on a respective label stick). In some embodiments, the italicized descriptors in table 700 represent a graphic that is placed on the label stick (e.g., in some embodiments, the “siding thickness measurement” descriptor indicates that the label includes a measurement graphic (e.g., a ruler), and in some embodiments, the “arrow” descriptor indicates that the label includes a graphic for an arrow).

FIG. 7B is a second portion 702 of table 700.

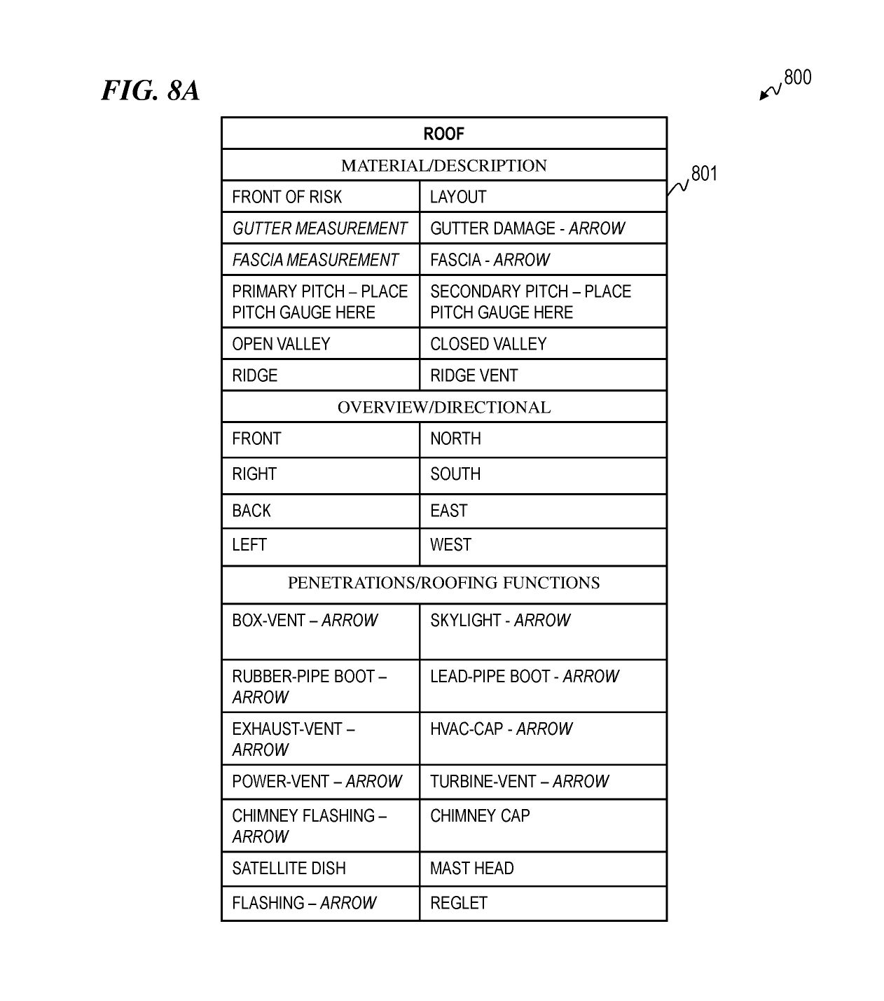

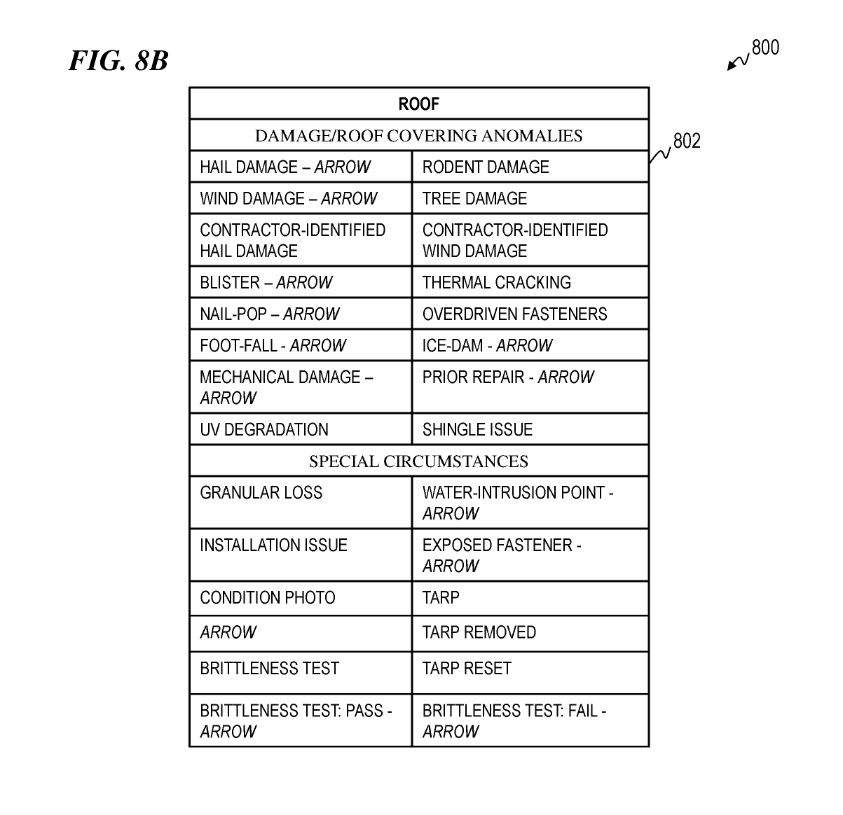

FIG. 8A is a first portion 801 of a table 800 showing one embodiment of labels in a ROOF category that are used in combination with one or more embodiments of the above-described label sticks. In some embodiments, each non-bolded, all-caps descriptor (e.g., “MATERIAL/DESCRIPTION”) represents a subcategory of labels. In some embodiments, the label sticks for all of the labels in table 800 (both FIG. 8A and FIG. 8B) are held together in a single collection of label sticks (in some such embodiments, each subcategory is distinguished within the single collection using a color-coded bar at the end of each respective label stick; in other such embodiments, each subcategory is distinguished in some other suitable manner such as the embodiments described in FIGS. 2A-2C, FIGS. 3A-3D, and the like). In some embodiments, the two columns of labels in table 800 represent labels used on the front and back sides of the label sticks (e.g., in some embodiments, each respective row of labels represents the front-side label (left-hand column) and back-side label (right-hand column) used on a respective label stick). In some embodiments, the italicized descriptors in table 800 represent a graphic that is placed on the label stick (e.g., in some embodiments, the “Gutter measurement” descriptor indicates that the label includes a measurement graphic (e.g., a ruler), and in some embodiments, the “arrow” descriptor indicates that the label includes a graphic of an arrow).

FIG. 8B is a second portion 802 of table 800.

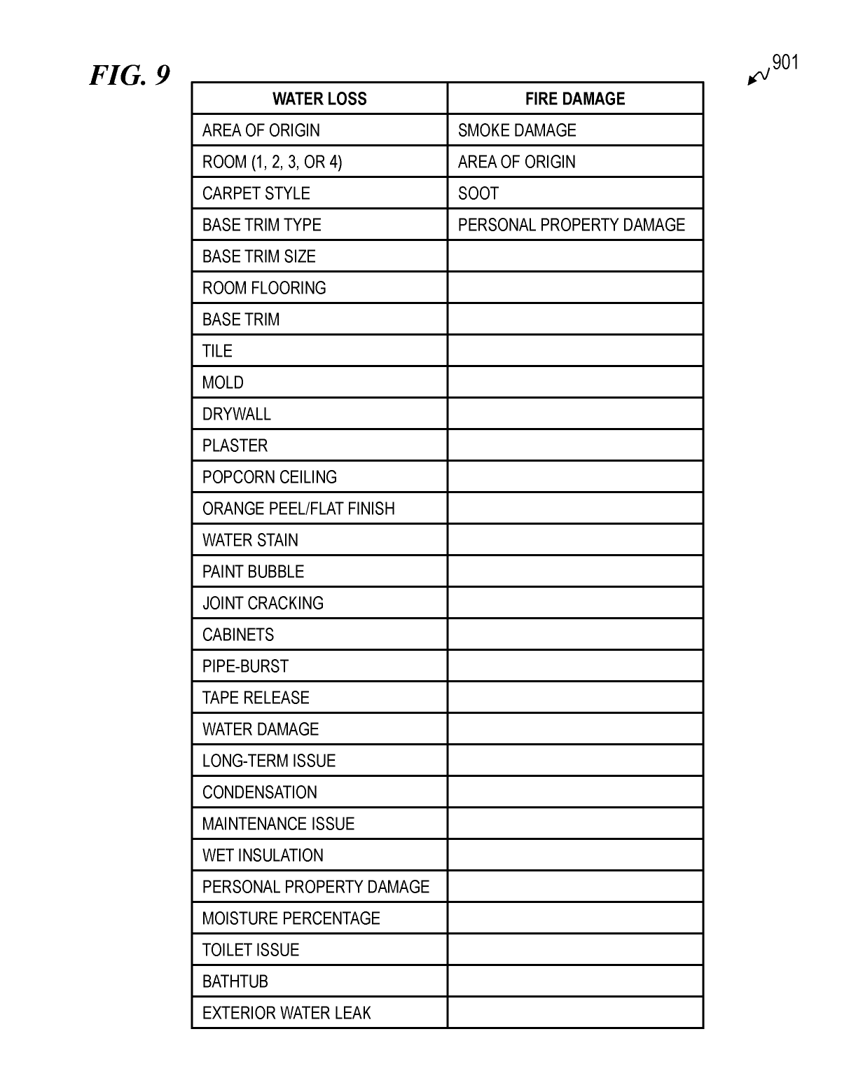

FIG. 9 is a table 901 showing one embodiment of labels that are used in combination with one or more embodiments of the above-described label sticks. In some embodiments, each column represents a category of labels (e.g., Water Loss, Fire Damage, and the like) used on a respective plurality of label sticks. In some embodiments, the label sticks for all of the labels in table 901 are held together in a single collection of label sticks (in some such embodiments, each category is distinguished within the single collection using a color-coded bar at the end of each respective label stick; in other such embodiments, each category is distinguished within the single collection using any other suitable approach such as the embodiments described in FIGS. 2A-2C, FIGS. 3A-3D, and the like). In other embodiments, the label sticks for each category of labels are held together as separate, category-based collections of label sticks (e.g., a first collection of held-together label sticks for Water Damage labels, and a second collection of held-together label sticks for Fire Damage labels). In still other embodiments, the four “FIRE DAMAGE” labels are placed on the back-side of the label sticks that contain the first four “WATER LOSS” labels.

In some embodiments, the present invention provides an apparatus that includes a first plurality of durable cards; one or more information labels on each of the first plurality of durable cards; and a ring holding the first plurality of durable cards together such that the cards may be rotated around the ring in a manner that allows any one of the plurality of durable cards to be placed in front of the others of the plurality of durable cards with one or more edges of the plurality of durable cards aligned, such that one of the information labels is visible on a top one of the plurality of cards and the other cards and their information labels are behind the top one of the plurality of cards and are largely not visible.

In some embodiments of the apparatus, each one of the first plurality of durable cards has a different length than the others of the first plurality of durable cards. In some embodiments, each one of the first plurality of durable cards has a different shape than the others of the first plurality of durable cards.

In some embodiments, the present invention provides a method of annotating a photograph that includes providing a first plurality of cards including a first card and a second card, wherein each one of the first plurality of cards includes a first structural characteristic, wherein each one of the first plurality of cards includes one or more information labels, and wherein the first structural characteristic of the first card is different than the first structural characteristic of the second card; attaching the first plurality of cards together such that each one of the first plurality of cards can be rotated relative to each other; selecting at least a first card of the first plurality of cards; and positioning the selected at least first card such that the one or more information labels of the selected at least first card is visible in a scene captured by a camera during the photographing of the scene by the camera.

In some embodiments of the method, the first structural characteristic is a length of each one of the first plurality of cards. In some embodiments, the first structural characteristic is a shape of each one of the first plurality of cards. In some embodiments, the attaching of the first plurality of cards together includes connecting the first plurality of cards together with a ring. In some embodiments, the attaching of the first plurality of cards together includes connecting the first plurality of cards together with a rivet.

In some embodiments, the method further includes providing a second plurality of cards, wherein each one of the second plurality of cards includes one or more information labels, and wherein each one of the second plurality of cards includes a second structural characteristic; and attaching the second plurality of cards together with the first plurality of cards such that each one of the first and second plurality of cards can be rotated relative to each other, wherein the one or more information labels in the first plurality of cards is in a first category, and wherein the one or more information labels in the second plurality of cards is in a second category. In some such embodiments, the first structural characteristic of each one of the first plurality of cards, including the first card and the second card, is equivalent in order to indicate the first category associated with the first plurality of cards, wherein the second structural characteristic of each one of the second plurality of cards is equivalent in order to indicate the second category associated with the second plurality of cards, and wherein the first structural characteristic is different than the second structural characteristic.

In some embodiments of the method, the one or more information labels includes text. In some embodiments, the one or more information labels includes a graphic. In some embodiments, the one or more information labels includes text and a graphic. In some embodiments, the first card includes a space to add a note to identify a category associated with the first plurality of cards. In some embodiments, the selecting of the at least first card includes rotating the at least first card away from non-selected cards of the first plurality of cards, wherein the non-selected cards remain in a collapsed position overlapping each other. In some embodiments, the positioning of the selected at least first card includes placing the first plurality of cards in a mount such that the selected at least first card is visible in the scene and such that the non-selected cards of the first plurality of cards are not visible in the scene.

In some embodiments, the present invention provides a photograph-annotation device that includes a first plurality of cards including a first card and a second card, wherein each one of the first plurality of cards includes a first structural characteristic, wherein each one of the first plurality of cards includes one or more information labels, and wherein the first structural characteristic of the first card is different than the first structural characteristic of the second card; and an attachment mechanism configured to hold the first plurality of cards together such that each one of the first plurality of cards can be rotated relative to each other.

In some embodiments of the device, the first structural characteristic is a length of each one of the first plurality of cards. In some embodiments, the first structural characteristic is a shape of each one of the first plurality of cards. In some embodiments, the attachment mechanism includes a ring. In some embodiments, the attachment mechanism includes a rivet. In some embodiments, the one or more information labels includes text. In some embodiments, the one or more information labels includes a graphic. In some embodiments, the one or more information labels includes text and a graphic. In some embodiments, the one or more information labels includes a geometric-scale graphic. In some embodiments, the first card includes a space to add a note to identify a category associated with the first plurality of cards.

In some embodiments, the apparatus further includes a second plurality of cards, wherein each one of the second plurality of cards includes one or more information labels, wherein each one of the second plurality of cards includes a second structural characteristic, wherein the attachment mechanism is further configured to hold the second plurality of cards together with the first plurality of cards such that each one of the first and second plurality of cards can be rotated relative to each other, wherein the one or more information labels in the first plurality of cards is in a first category, and wherein the one or more information labels in the second plurality of cards is in a second category. In some such embodiments, the first structural characteristic of each one of the first plurality of cards, including the first card and the second card, is equivalent in order to indicate the first category associated with the first plurality of cards, wherein the second structural characteristic of each one of the second plurality of cards is equivalent in order to indicate the second category associated with the second plurality of cards, and wherein the first structural characteristic is different than the second structural characteristic.

In some embodiments, the present invention provides an apparatus for annotating a photograph that includes a first plurality of cards including a first card and a second card, wherein each one of the first plurality of cards includes one or more information labels; means for attaching the first plurality of cards together such that each one of the first plurality of cards can be rotated relative to each other; and means for distinguishing the first card from the second card when the first plurality of cards are in an assembled and collapsed position.

In some embodiments, the present invention provides a method of annotating a photograph that includes providing a first plurality of cards, wherein each one of the first plurality of cards has a different geometry relative to others of the first plurality of cards, wherein each one of the first plurality of cards includes one or more information labels; connecting the first plurality of cards together such that the first plurality of cards is in a stack having a top card, and such that each one of the first plurality of cards can be rotated around a common axis relative to others of the first plurality of cards in the stack; selecting at least a first card of the first plurality of cards; positioning the selected first card such that the one or more information labels of the selected first card is visible in a scene; and capturing a digital image of the scene including an image of the selected first card.

In some embodiments of the method, the different geometries include different lengths for each one of the first plurality of cards. In some embodiments, the connecting of the first plurality of cards together includes passing a ring through the common axis; and the positioning of the selected first card includes reordering the first plurality of cards in the stack such that the selected first card is the top card of the stack.

In some embodiments, the method further includes printing an insurance appraisal report that includes the captured digital image of the scene including the image of the selected first card.

In some embodiments of the method, the connecting of the first plurality of cards together includes passing a rivet through the common axis; and the positioning of the selected first card includes rotating the selected first card away from non-selected cards of the first plurality of cards such that the one or more information labels on the selected first card are visible in the scene and such that the non-selected cards remain in the stack.

In some embodiments, the first plurality of cards includes the first card having a first geometry and a second card having a second geometry, the method further including providing a second plurality of cards that includes the first card, wherein each one of the second plurality of cards includes one or more information labels, and wherein each one of the second plurality of cards has the first geometry; providing a third plurality of cards that includes the second card, wherein each one of the third plurality of cards includes one or more information labels, and wherein each one of the third plurality of cards has the second geometry; and connecting the second plurality of cards to the third plurality of cards. In some embodiments, the one or more information labels in the second plurality of cards is in a first category of insurance damage types, and wherein the one or more information labels in the third plurality of cards is in a second category of insurance damage types. In some embodiments, the one or more information labels in the second plurality of cards is in a first category of insurance damage types, wherein the first geometry includes a first shape at an end of each one of the second plurality of cards, wherein the one or more information labels in the third plurality of cards is in a second category of insurance damage types, and wherein the second geometry includes a second shape at an end of each one of the third plurality of cards.

In some embodiments of the method, the first card includes an area suitable for writing with a marker to add a note to identify a category associated with the first plurality of cards. In some embodiments, the positioning of the selected first card includes placing the first plurality of cards in a mount.

In some embodiments, the present invention provides a photograph-annotation device that includes a first plurality of cards including a first card and a second card, wherein each one of the first plurality of cards has a different geometry relative to others of the first plurality of cards, wherein each one of the first plurality of cards includes one or more information labels; and an attachment mechanism configured to hold the first plurality of cards together such that the first plurality of cards is in a stack having a top card, and such that each one of the first plurality of cards can be rotated around a common axis relative to others of the first plurality of cards in the stack.

In some embodiments of the device, the different geometries include different lengths for each one of the first plurality of cards. In some embodiments, the different geometries include different shapes at an end of each one of the first plurality of cards. In some embodiments, the attachment mechanism includes a ring. In some embodiments, the attachment mechanism includes a rivet. In some embodiments, the one or more information labels includes a geometric-scale graphic. In some embodiments, the first card includes an area suitable for writing with a marker to add a note to identify a category associated with the first plurality of cards.

In some embodiments, the first plurality of cards includes the first card having a first geometry and the second card having a second geometry, the device further including a second plurality of cards that includes the first card, wherein each one of the second plurality of cards includes one or more information labels, and wherein each one of the second plurality of cards has the first geometry; and a third plurality of cards that includes the second card, wherein each one of the third plurality of cards includes one or more information labels, and wherein each one of the third plurality of cards has the second geometry, wherein the attachment mechanism is further configured to connect the second plurality of cards to the third plurality of cards. In some embodiments, the one or more information labels in the second plurality of cards is in a first category of insurance damage types, and wherein the one or more information labels in the third plurality of cards is in a second category of insurance damage types. In some embodiments, the one or more information labels in the second plurality of cards is in a first category of insurance damage types, wherein the first geometry includes a first shape at an end of each one of the second plurality of cards, wherein the one or more information labels in the third plurality of cards is in a second category of insurance damage types, and wherein the second geometry includes a second shape at an end of each one of the third plurality of cards.

In some embodiments, the present invention provides an apparatus for annotating a photograph that includes a first plurality of cards including a first card and a second card, wherein each one of the first plurality of cards includes one or more information labels; means for connecting the first plurality of cards together in a stack having a top card such that each one of the first plurality of cards can be rotated relative to each other, and wherein the first card is not the top card; and means for manually selecting the first card from others of the first plurality of cards when the first plurality of cards are in a connected, stacked and collapsed orientation.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A method of annotating a photograph comprising:
providing a first plurality of cards, wherein each one of the first plurality of cards has a different geometry relative to others of the first plurality of cards, wherein each one of the first plurality of cards includes one or more information labels;
connecting the first plurality of cards together such that the first plurality of cards is in a stack having a top card, and such that each one of the first plurality of cards can be rotated around a common axis relative to others of the first plurality of cards in the stack;
selecting at least a first card of the first plurality of cards;
positioning the selected first card such that the one or more information labels of the selected first card is visible in a scene; and
capturing a digital image of the scene including an image of the selected first card.

2. The method of claim 1, wherein the different geometries include different lengths for each one of the first plurality of cards.

3. The method of claim 1,
wherein the connecting of the first plurality of cards together includes passing a ring through the common axis; and
wherein the positioning of the selected first card includes reordering the first plurality of cards in the stack such that the selected first card is the top card of the stack.

4. The method of claim 1, further comprising printing an insurance appraisal report that includes the captured digital image of the scene including the image of the selected first card.

5. The method of claim 1,
wherein the connecting of the first plurality of cards together includes passing a rivet through the common axis; and
wherein the positioning of the selected first card includes rotating the selected first card away from non-selected cards of the first plurality of cards such that the one or more information labels on the selected first card are visible in the scene and such that the non-selected cards remain in the stack.

6. The method of claim 1, wherein the first plurality of cards includes the first card having a first geometry and a second card having a second geometry, the method further comprising:
providing a second plurality of cards that includes the first card, wherein each one of the second plurality of cards includes one or more information labels, and wherein each one of the second plurality of cards has the first geometry;
providing a third plurality of cards that includes the second card, wherein each one of the third plurality of cards includes one or more information labels, and wherein each one of the third plurality of cards has the second geometry; and
connecting the second plurality of cards to the third plurality of cards.

7. The method of claim 6, wherein the one or more information labels in the second plurality of cards is in a first category of insurance damage types, and wherein the one or more information labels in the third plurality of cards is in a second category of insurance damage types.

8. The method of claim 6, wherein the one or more information labels in the second plurality of cards is in a first category of insurance damage types, wherein the first geometry includes a first shape at an end of each one of the second plurality of cards, wherein the one or more information labels in the third plurality of cards is in a second category of insurance damage types, and wherein the second geometry includes a second shape at an end of each one of the third plurality of cards.

9. The method of claim 1, wherein the first card includes an area suitable for writing with a marker to add a note to identify a category associated with the first plurality of cards.

10. The method of claim 1, wherein the different geometries include different shapes at an end of each one of the first plurality of cards.

11. A photograph-annotation device comprising:
a first plurality of cards including a first card and a second card, wherein each one of the first plurality of cards has a different geometry relative to others of the first plurality of cards, wherein each one of the first plurality of cards includes one or more information labels; and
an attachment mechanism configured to hold the first plurality of cards together such that the first plurality of cards is in a stack having a top card, and such that each one of the first plurality of cards can be rotated around a common axis relative to others of the first plurality of cards in the stack.

12. The device of claim 11, wherein the different geometries include different lengths for each one of the first plurality of cards.

13. The device of claim 11, wherein the attachment mechanism includes a ring.

14. The device of claim 11, wherein the attachment mechanism includes a rivet.

15. The device of claim 11, wherein the one or more information labels includes a geometric-scale graphic.

16. The device of claim 11, wherein the first card includes an area suitable for writing with a marker to add a note to identify a category associated with the first plurality of cards.

17. The device of claim 11, wherein the first plurality of cards includes the first card having a first geometry and the second card having a second geometry, the device further comprising:
a second plurality of cards that includes the first card, wherein each one of the second plurality of cards includes one or more information labels, and wherein each one of the second plurality of cards has the first geometry; and
a third plurality of cards that includes the second card, wherein each one of the third plurality of cards includes one or more information labels, and wherein each one of the third plurality of cards has the second geometry, wherein the attachment mechanism is further configured to connect the second plurality of cards to the third plurality of cards.

18. The device of claim 17, wherein the one or more information labels in the second plurality of cards is in a first category of insurance damage types, and wherein the one or more information labels in the third plurality of cards is in a second category of insurance damage types.

19. The device of claim 17, wherein the one or more information labels in the second plurality of cards is in a first category of insurance damage types, wherein the first geometry includes a first shape at an end of each one of the second plurality of cards, wherein the one or more information labels in the third plurality of cards is in a second category of insurance damage types, and wherein the second geometry includes a second shape at an end of each one of the third plurality of cards.

20. An apparatus for annotating a photograph comprising:
a first plurality of cards including a first card and a second card, wherein each one of the first plurality of cards includes one or more information labels;
means for connecting the first plurality of cards together in a stack having a top card such that each one of the first plurality of cards can be rotated relative to each other, and wherein the first card is not the top card; and
means for manually selecting the first card from others of the first plurality of cards when the first plurality of cards are in a connected, stacked and collapsed orientation.
